(19) United States
(12) Patent Application Publication
(10) Pub. No.: US 2007/0136746 A1
(43) Pub. Date: Jun. 14, 2007

(54) User context based dynamic service combination system and method

(75) Inventors: Jung-Sook Bae, Daejeon-city (KR); Kyung-Sook Kim, Daejeon-city (KR); Gyung-Chul Shin, Daejeon-city (KR); Jae-Ho Kim, Daejeon-city (KR); Seong-Im Yoon, Daejeon-city (KR); Jong-Yun Lee, Cheongju-city (KR); Sun-Young Lee, Cheongju-city (KR); Byoung-Cheol Shin, Jinhae-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,580

(22) Filed: Dec. 8, 2006

(30) Foreign Application Priority Data
Dec. 8, 2005 (KR) 10-2005-0119893
Apr. 24, 2006 (KR) 10-2006-0036571

(51) Int. Cl. H04N 7/025; G06F 13/00; H04N 7/10; G06F 3/00; H04N 5/445

(52) U.S. Cl. 725/35; 725/34; 725/46

(57) ABSTRACT

A dynamic service combination system and service provision method using user's context information are provided. a service may be dynamically provided and a new service may be combined to be provided to a service user using the user's context information. In addition, a new ontology may be configured by finding a new knowledge through AI engine's data mining, and thus a success rate of the service provision may be increased, and a dynamic service provision may be achieved.

### CROSS-REFERENCE TO RELATED APPLICATION

This application claims priority to and the benefit of Korean Patent Application No. 10-2005-0119893 & 10-2006-0036571 filed in the Korean Intellectual Property Office on Dec. 8, 2005 & Apr. 24, 2006 the entire contents of which are incorporated herein by reference.

### BACKGROUND OF THE INVENTION

(a) Field of the Invention

The present invention relates to a service combination system and method. More particularly, the present invention relates to a service combination system and method for dynamically composing a new service based on user context information.

(b) Description of the Related Art

Recently, a range of computer usage has expanded from a personal computing area to a ubiquitous computing area as information industry and mobile communication technology have been developed. In the ubiquitous computing service, a terminal senses changes in their environment and automatically adapts and acts based on these changes based on user needs and preferences, a computer senses a state of user, analyzes the sensed context, and provides a personalized service appropriate to the context. Accordingly, services are required to adaptively vary according to a context including a present user location, and a user activity as well as service capabilities of service terminal in a ubiquitous computing environment.

In addition, a general service provisioning serves to search a service in a middle ware using information registered by service providers and to provide the same to the user. However, in a ubiquitous computing environment for satisfying a user wanted to use a service regardless of a changeable user context and peripheral environment, it is not an end to simply search and provide a service.

Using such a conventional system, it is problematic that a service not registered on the system may not be provided to the user because such a conventional system provides an only user's desired service regardless of user's present context.

Although a proper service is searched and provided considering the user's context information user, it is impossible to search a user's service using history, fine a new service combination rule, and provides a service combination mapping with the user' context. That is, although the proper service may be provided by combining contents focused on only a user's consumption pattern, it is impossible to perform a service combination so as to provide a service considering the user's present context and user's preference.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a context-based service provision system and method having advantages of providing a new service to a user by dynamically combining the same considering user's information, peripheral context information, and user's service using history gathered in an physical layer of a ubiquitous environment.

An exemplary embodiment of the present invention provides a context-based service provision system which a service provider's service is dynamically provided to a service user based on user context information, the context-based service provision system includes a physical layer sensing context information including service a user's information, a preference, a peripheral environment state, a service user's body state, and a service context;

a context awareness layer recognizing, storing, and managing the service user's context information base on the context information sensed from the physical layer;

a service provisioning layer for estimating and combining a service based on the stored context information of the context awareness layer and a service using history service, providing a service user's adaptive service; and

an application layer being connected to the service user and the service provider, and transmitting a service user request information and a service provision information to the service provisioning layer.

Other exemplary embodiment of the present invention provides a context-based service provision method in which a service provision system provides a service of a service provider to a service user based on user's context information, the context-based service provision method includes (a) searching a service based on a service query requested by the service user;

(b) analyzing a service using pattern based on a service user's using service history information when there is no service to be provided based on the query to the service user; and

(c) gathering a service combination pattern corresponding to the service user based on the analysis, and providing a combined service to the service user after combining a service based on the gathered service combination pattern.

### BRIEF DESCRIPTION OF THE DRAWINGS

FIG. 1 is a block diagram of a network for a dynamic service combination and service provision using user's context information according to an exemplary embodiment of the present invention.

FIG. 2 is a block diagram of a context-based service provision system according to an exemplary embodiment of the present invention.

FIG. 3 is a block diagram of a service provider according to an exemplary embodiment of the present invention.

FIG. 4 is a flowchart of a dynamic service provision method using user's context information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

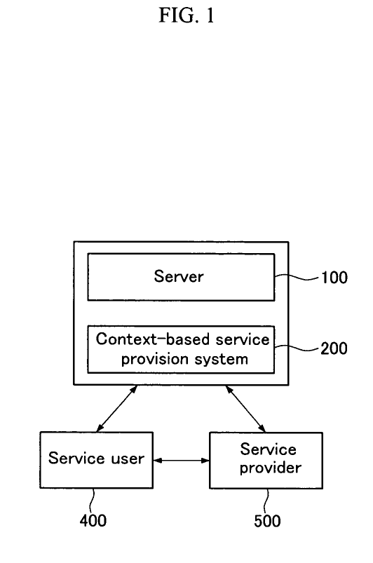

FIG. 1 is a block diagram of a network for a dynamic service combination and service provision using user's context information according to an exemplary embodiment of the present invention.

As shown in FIG. 1, in order to provide a dynamic service using user's context information, a information provision server 100 provides information to a context-based service provision system 200, the context-based service provision system 200 is coupled to a service provider 500 and a service user 400 provided with a service from the service provider 500. Herein, user's context information includes a user's present position, a body state, electrical capacity, and a service context.

The information provision server 100 provides user's context information, basic service information, and transaction storying unit information to the context-based service provision system 200, in which this information relates to the service user 400 receiving the service from the service provider 500. Herein, the user's context information includes a service user 400's service mobility preference and a user's equipment preference.

In addition, the basic service information imply such basic information as a type of the service provided to the service user 400 and an environment which the service may be performed. The transaction storing unit records and stores user's service transaction information provided to the service user 400.

The context-based service provision system 200 searches a user's request service based on the user's context information stored at the information provision server 100 and informs service provider information of the service user 400, the service provider information imply which service provider 500 provides a service mapping with the user's context information. In addition, it performs a service combination function so as to provide an optimum service to the service user 400 using a user service context history.

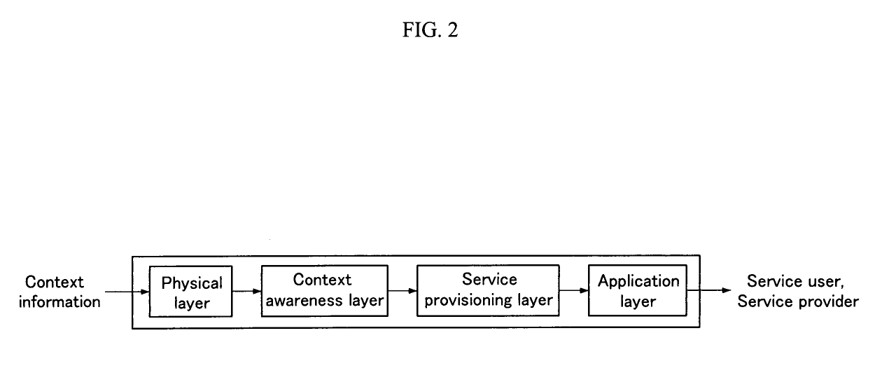

A dynamic service provision system using the user's context information may be described with reference to FIG. 2.

FIG. 2 is a block diagram of a context-based service provision system according to an exemplary embodiment of the present invention.

As shown in FIG. 2, the context-based service provision system 200 includes a application layer 210, a service provisioning layer 220, a context awareness layer 230, and a physical layer 240.

The application layer 210 performs a connection function such that the service provided from the service provider 500 may be provided in concordance with the service user 400's context. The application layer 210 connects the service user 400 and the service provider 500 to the context-based service provision system 200.

The service provisioning layer 220 searches a service according to a service user 400's request and the context information, and estimates a searched service. In addition, in order to provide a proper service to the service user 400 based on the service user 400's context information and the given service using history, a new service is combined, estimated, and provided to the service user 400.

The physical layer 240 determines a service user 400 requesting a service provision, and senses service user information, preference, and context information about a peripheral environment state of the service user, and provides the same to the context awareness layer 230. That is, it includes a service user 400′ profile, network information service about an environment which the user receives a service, a service receive equipment information, and sensor information gathered by a sensor, and provides the same to the context awareness layer 230.

Herein, the sensor implies a mean for obtaining context information about a profile, position, location, mission, temperature of the service user 400 and equipment of the service user 400 for displaying a service. For example, the position sensor may gather present position information of the service user 400. In addition, a state sensor included in the service user 400 or partly attached in the service user 400 may gather a body state of the service user 400 (for example, temperature, biorhythm, or the like).

The context awareness layer 230 gathers service user information, preference, and context information from the physical layer 240, converts the same, and stores the same at a context information storing unit (not shown) therein.

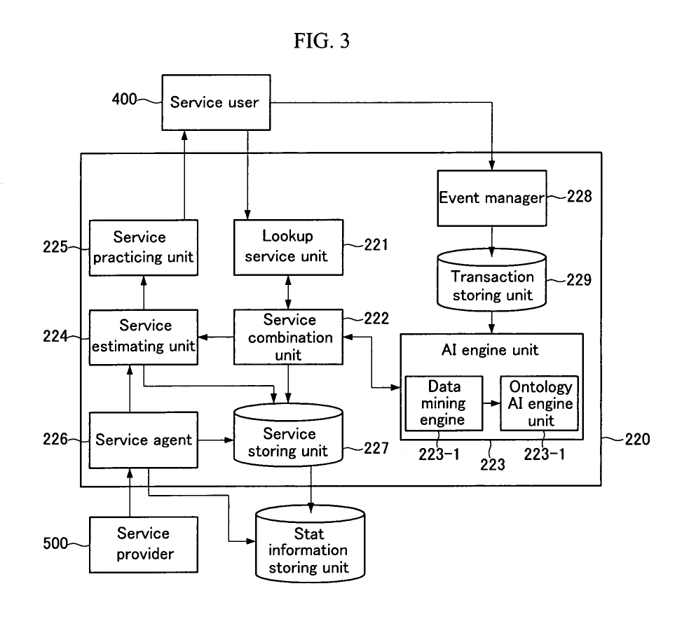

Next, a service provisioning layer 220 for dynamically providing a service using the context information of the service user 400 among constituent elements of the context-based service provision system 220 will be described with reference to FIG. 3 in detail.

FIG. 3 is a block diagram of a service provider according to an exemplary embodiment of the present invention.

As shown in FIG. 3, the service provisioning layer 220 includes a lookup service unit 221, a service combination unit 222, an artificial intelligence (AI) an engine unit 223, a service estimating unit 224, a service practicing unit 225, a service agent 226, a service storing unit 227, an event manager 228, and a transaction storing unit 229.

The lookup service unit 221 allows the service user 400 corresponding to a client to search and use registered information of the lookup service. That is, it receives service information queried by the service user 400, and searches the input service information from the service storing unit 227.

The service combination unit 222 uses basic services using the artificial intelligence engine unit 223, and composing a new service by combining the basic services in order to provide an optimum service to the service user 400. At this time, service using history information which the user has used until now may be used, the service using history information are managed by the event manager and stored by the transaction storing unit 229

The artificial intelligence engine unit 223 includes a data mining engine 223-1 and ontology engine 223-2. The data mining engine 223-1 analyzes service user 400's service consumption transaction pattern stored at the transaction storing unit 229 and uses the same on combining a service. That is, such a new knowledge as a specified service preference is discovered using the given service using information and context information and is used on combining as service. Herein, an inner-algorithm of the data mining engine 223-1 or ontology engine 223-2 may be freely changed.

The ontology engine 223-2 defines and manages a correlation between the basic services. The data mining engine 223-1 allows the ontology engine 223-2 to update service information based on a new discovered service combination. The service storing unit 227 stores supportable service information capable of providing by being basically combined by the ontology engine 223-2.

The service estimating unit 224 estimates a service set or combined service sets searched based on the context information storing unit in the context awareness layer 230 such that optimum service set may be composed. Herein, the context information storing unit stores various context information gathered by a plurality of sensors placed in the physical layer 240 and service estimating information provided from the service estimating unit 224. At this time, the estimating information imply to information about that the service provided the service user is concordance with the service user 400's request service and is an optimum service.

The service practicing unit 225 practices the service searched by the lookup service unit 221, estimated by the service estimating unit 224, and determined being proper to the service user 400 and provides the optimum service to the service user 400. As a result, it transmits a resultant expression interface to a presentation of the service user 400. That is, when the service is expressed in a terminal which the service user 400 has and uses, the service is provided to the service user 400.

The service agent 226 gathers a plurality of server information of a ubiquitous network using meta data of the basic service, and manages a cross-action with the service provider 500. The cross-action implies that the service agent 226 manages and registers the service provided to the service provider 500. That is, it manages the service provider information provided from the application layer's server 100 and the service provider 500 allows the service storying unit 227 to store the same.

The service storing unit 227 includes an interest service storing unit and basic service storing unit. The interest service storing unit stores service information which may directly provide to service user 400 without additional amending the same. The basic service storing unit stores the meta data of the basic service and the service information.

The transaction storing unit 229 stores a transaction required until the service user 400 consume the service. That is, the transaction storing unit 229 stores service history information thereof which the service user 400 has used. The artificial intelligence engine 223 analyzes the stored service using pattern of the transaction storing unit 229, the data mining engine 223-1 fines a specified service preference and a new service combination pattern, the found new service combination pattern reconfigures a ontology engine 223-2, and uses the same on combining a service.

The event manager 228 receives the used service information about what it has used until now from the service user 400 and manages the service using history.

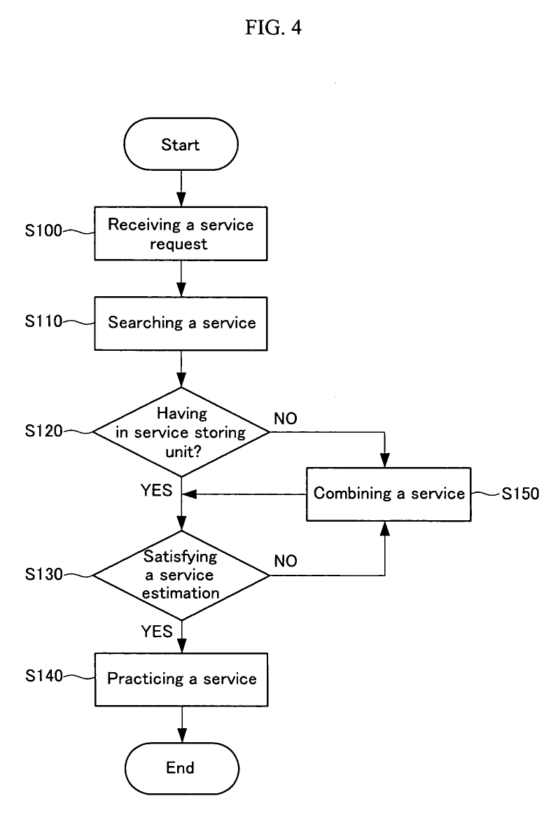

A dynamic service provision method will be described with reference to FIG. 4 in the dynamic service provision system using the user's context information described as above.

FIG. 4 is a flowchart of a dynamic service provision method using user's context information according to an exemplary embodiment of the present invention.

As shown in FIG. 4, the service user 400 coupled to the application layer 210 requests the lookup service unit 221 of the service provisioning layer 220 to provide a service (S100), the lookup service unit 221 searches whether the service in concordance with a query which the service user 400 requests is stored at the service storing unit 227 (S110).

It is determined that the requested service is in the service storing unit 227 by the search of the service storing unit 227 (S120). When the requested service is in the service storing unit 227, a list of the searched services is transmitted to the service estimating unit 224 of the service provisioning layer 220 and it is estimated that it is proper to the user's context information (S130). Herein, the service estimating may be performed by two steps.

First, it is checked that the searched service is in concordance with the query of the service user 400, and if only, it is checked that the searched service is an optimum service for the service user 400. When the two steps of estimating are satisfied, the searched service is determined as a proper service to the user's context information, and is practiced and provided to the service user 400 (S140).

When that the searched service is not in concordance with the query of the service user 400, it is informed of the service user 400 that there is no proper service mapping with the query and the service combination unit 222 performs a service combination (S150).

When there is no the service user 400's requested service after searching the same by the service storing unit 227 at the step S120, the lookup service unit 221 requests the service combination unit 222 to combine a service. At this time, the artificial intelligence engine 223 of the service provisioning layer is used to perform a service combination (S150).

The service estimating unit 224 receives the combined service of the service combination unit 222 and performs a service estimating (S130), and provides and practices the service through service practicing unit 225 when it determines that it is proper to provide the same to the service user 400 (S140).

Herein, a program or a recording medium thereof for realizing function corresponding to the component of the exemplary embodiments of the present invention may be included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment, using the user's context information, the service may be dynamically provided and the new service are combined and provided.

In addition, by configuring a new ontology by data-mining of the artificial intelligence engine, a dynamic service may be provided as well as a success rate of the service provision may be enhanced.

What is claimed is:

1. A context-based service provision system which a service provider's service is dynamically provided to a service user based on user context information, the context-based service provision system comprising:
a physical layer sensing context information including service a user's information, a preference, a peripheral environment state, a service user's body state, and a service context;
a context awareness layer recognizing, storing, and managing the service user's context information base on the context information sensed from the physical layer;
a service provisioning layer for estimating and combining a service based on the stored context information of the context awareness layer and a service using history service, providing a service user's adaptive service; and
an application layer being connected to the service user and the service provider, and transmitting a service user request information and a service provision information to the service provisioning layer.

2. The context-based service provision system of claim 1, wherein
the service provisioning layer comprises
a lookup service unit for performing a search to a queried service in response to a service provision request of the service user;
a service storing unit storing a plurality of service information therein, and performing a search to the requested service of the lookup service unit;
an event manager for managing the service user's using service history information;
a transaction storing unit the service user's service history information managed by the event manager;
an artificial intelligence engine unit for finding and outputting a service combination pattern based on the service history information stored at the transaction storing unit;
a service combination unit performing a service combination based on the service combination patterns found from the artificial intelligence engine unit;
a service estimating unit determining whether the searched service of from the service storing unit is adaptive to the service user;
a service practicing unit for displaying a service to a service' user terminal when the service estimated by the service estimating unit is adaptive to the service user; and
a service agent for managing and registering a service which the service provider provides to the service user.

3. The context-based service provision system of claim 2, wherein
the artificial intelligence engine unit comprises a data mining engine unit for analyzing the service user's service using pattern based on the stored service history information of the transaction storing unit, finding a service user's service preference based on the analyzed using pattern, and extracting a new service combination pattern; and
an ontology engine unit for updating the service information by defining and managing a correlation between a basic service and a new service combination pattern based on the extracted new service combination pattern of from the data mining engine unit.

4. The context-based service provision system of claim 1, further comprising a service server for providing the service user's user context information, basic service information, and transaction storing information.

5. The context-based service provision system of claim 4, wherein
the user context information includes at least one of a user's profile, a user's present position or location, such user's present state information as a user' present position peripheral temperature.

6. A context-based service provision method in which a service provision system provides a service of a service provider to a service user based on user's context information, the context-based service provision method comprising:
(a) searching a service based on a service query requested by the service user;
(b) analyzing a service using pattern based on a service user's using service history information when there is no service to be provided based on the query to the service user; and
(c) gathering a service combination pattern corresponding to the service user based on the analysis, and providing a combined service to the service user after combining a service based on the gathered service combination pattern.

7. The context-based service provision method of claim 6, further comprising, wherein when the service to be provided to the service user has been provided at the step (b),
(i) estimating whether the gathered service is an service user adaptive service based on the search of the service provision system; and
(ii) providing a service through a service user's terminal when the gathered service is an service user adaptive service.

8. The context-based service provision method of claim 7, wherein
the (i) estimating a service includes
(i-1) determining whether the gathered service is in concordance with a query provided on the service user's service request; and
(i-2) determining whether to be a service user-adaptive service based on the service user's context information when the gathered service is concordance with the query of the service user.

9. The context-based service provision method of claim 8, further comprising when not satisfying any one of the steps (i-1) and (i-2),
informing it to the service user that there is no service adaptive to the query, and analyzing the service using pattern of the step (b).
